(19) United States
(12) Patent Application Publication
(10) Pub. No.: US 2009/0047958 A1
(43) Pub. Date: Feb. 19, 2009

(54) Neighbor List Management for User Terminal

(76) Inventors: Anna Pucar Rimhagen, Motala (SE); Mikael Larsson, Goteborg (SE); Erik Lars Westerberg, Enskede (SE)

Correspondence Address: COATS & BENNETT, PLLC, 1400 Crescent Green, Suite 300, Cary, NC, 27518, US

(21) Appl. No.: 12/018,983

(22) Filed: Jan. 24, 2008

Related U.S. Application Data
(60) Provisional application No. 60/956,203, filed on Aug. 16, 2007.

(51) Int. Cl. H04Q 7/20

(52) U.S. Cl. 455/436

(57) ABSTRACT

Methods and apparatus for maintaining neighbor cell information for use in handover operations are disclosed. In an exemplary method, a mobile station maintains a high-priority neighbor cell list and a low-priority neighbor cell list, each list comprising one or more neighbor cell entries corresponding to candidate cells for handover. Signal strength measurements for candidate cells in the high-priority list are made according to a first measurement schedule, while signal strength measurements for candidate cells in the low-priority list are made according to a second measurement schedule. In one or more embodiments, the low-priority cells are measured less frequently than the high-priority neighbor cells.

### RELATED APPLICATIONS

This application claims priority under 35 U.S.C. §119(e) from U.S. Provisional Patent Application Ser. No. 60/956,203, filed on 16 Aug. 2007 and entitled “Neighbor List Management for User Terminal.”

### BACKGROUND

The present invention relates generally to mobile communications networks, and, more particularly, to the management of neighbor cell lists by a user terminal in a mobile communications network.

In most cellular radio systems, a mobile station is required to search for and detect base stations (cells) to which the mobile station can connect and communicate. The state of the art includes methods for both the initial search and connection processes (e.g., as performed when a mobile station is first powered on), as well as for periodic monitoring of base station signals from neighboring cells to identify candidates for cell changes and handovers.

The methods used in various cellular radio systems (e.g. GSM, CDMA, WCDMA, WiMAX and LTE) to detect and monitor these so-called neighbor cells differ in some details, but share many features. A mobile station typically stores a list of frequencies on which to scan for beacon signals (e.g., a control channel) from potential base stations. If a beacon signal from the correct technology (e.g. WCDMA) is detected on one of the frequencies in the list, the mobile station attempts to read the corresponding system information. From the system information, the mobile station may determine an identity for the corresponding base station (cell), and whether or not the mobile station is allowed to connect to the base station. If the base station is eligible, the mobile station may begin periodic signal strength measurements of the beacon channel of that base station. The measured signal strength data is then used by cell selection and cell switching algorithms to determine which cell to connect to and whether to initiate a handover. In addition to signal strength measurements, other signal quality parameters may be measured and used for cell selection and cell switching.

In parallel to making signal strength measurements for each of several neighbor cells, the mobile station may periodically read identity information encoded on each neighbor cell's beacon signal (e.g., a common control channel). This practice reduces the possibility that a second base station using the same frequency for its beacon carrier fades in and is mistaken for being the first base station, a phenomenon that could lead to confused base station identification and faulty handover decisions. In GSM, for example, this re-identification procedure is repeated at least once every thirty seconds.

In current mobile communications systems, all mobile stations within a given cell measure signal strength for the same list of neighboring cells, regardless of where in the cell the mobile station is located. However, it many situations it is likely that two mobile stations within the same cell have quite different radio environments. A mobile station in one end of the cell may not “hear” neighboring cells adjacent to the opposite end of the cell. The cell geography, or the presence of buildings, may block radio wave propagation to one mobile terminal, but not another. One mobile station may be close to one or more micro-cells, or indoor cells, while another is out of range of these limited-range cells.

One concern with the current approach is that measurement accuracy is generally lowered when the number of neighboring cells to measure increases. (This typically occurs because less time is spent monitoring each neighbor cell, so as to avoid spending too much of the mobile station's time in neighbor cell monitoring.) Measuring neighboring cells that are not realistic handover candidates thus decreases the quality of the measurements of the realistic handover candidates. In some cases, such measurement errors may cause the mobile station to select a base station that is not the best handover candidate—in the worst case, the handover may fail and the connection may be dropped.

Furthermore, with the introduction of multi-technology radio networks (e.g., WCDMA/GSM/LTE) as well as the use of different cell layers (e.g., including micro-, macro-, indoor-, and home-base station cells), the number of neighboring cells to a given cell, especially a macro-cell, may become very large. Because scanning, measuring, and identifying neighbor cell signals consumes time and processing resources at the mobile terminal, it may be impossible for the mobile to frequently and accurately process all possible neighbor cells. Even where processing all neighbor cells is possible, measurement accuracy may suffer, and the mobile terminal may suffer degradations in throughput, battery life, or handover performance.

### SUMMARY

The present invention provides methods and apparatus for maintaining neighbor cell information for use in handover operations. In an exemplary method, a mobile station maintains a high-priority neighbor cell list and a low-priority neighbor cell list, each list comprising one or more neighbor cell entries corresponding to candidate cells for handover. Signal strength measurements for candidate cells in the high-priority list are made according to a first measurement schedule, while signal strength measurements for candidate cells in the low-priority list are made according to a second measurement schedule. In at least one embodiment, the low-priority cells are measured less frequently than the high-priority neighbor cells.

In various embodiments of the invention, the high-priority and low-priority neighbor cell lists are adjusted based on corresponding signal strength or other signal quality measurements. Thus, a neighbor cell entry may be moved from the high-priority list to the low-priority list if the signal strength measurements for that cell fall below a pre-determined threshold level for a pre-determined interval of time or for a pre-determined number of measurements. Similarly, neighbor cell entries may be moved from the low-priority list to the high-priority list if the signal strength measurements for that cell exceed a pre-determined threshold for a certain interval or number of measurements. In other embodiments, the number of entries in the high-priority list may be adjusted based on the signal strength measurements for candidate cells in the list.

By using multiple neighbor lists and performing signal measurement and/or cell confirmation procedures on different schedules for the two (or more) lists, mobile terminal resources that would otherwise be used for neighbor cell processing are freed. Thus, in some embodiments, battery life may be extended. In some embodiments, the freed resources may be used for processing additional data traffic. In various embodiments, the freed resources may be used to perform more frequent, or longer, signal strength measurements on the most likely handover candidates, thereby improving measurement accuracy.

Corresponding mobile terminal embodiments, configured to carry out one or more of the methods described herein for maintaining neighbor cell information are also disclosed. Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates a mobile communications network including a mobile terminal configured to use a single neighbor cell list.

FIG. 2 illustrates a mobile communications network including a mobile terminal configured to use a high-priority neighbor cell list and a low-priority neighbor cell list according to one or more embodiments of the present invention.

FIGS. 3A and 3B illustrate exemplary signal strength measurement and cell identity confirmation schedules.

FIG. 4 is a flow diagram illustrating an exemplary method for maintaining neighbor cell information at a mobile terminal.

FIG. 5 illustrates an exemplary mobile terminal configured according to one or more embodiments of the present invention.

### DETAILED DESCRIPTION

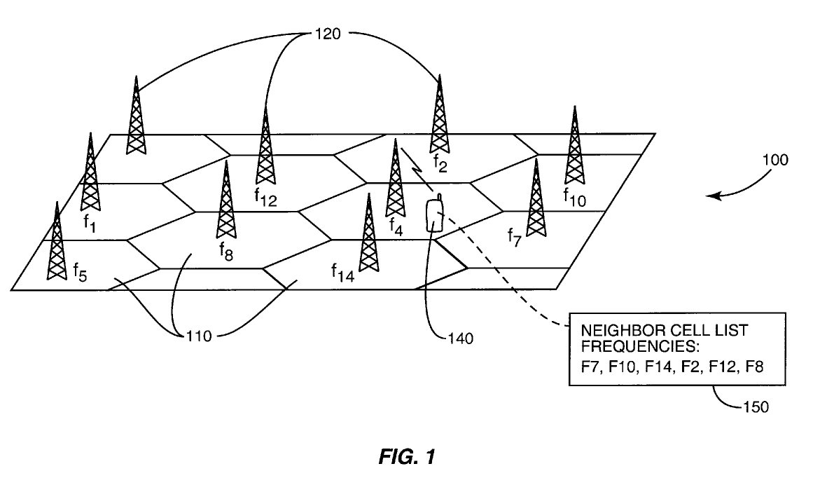

Referring now to the accompanying drawings, FIG. 1 illustrates a mobile communications network 100, which supports communication with one or more mobile stations 140 (also called user equipment, UEs, or mobile terminals) in a number of cells 110, each of which is served by a base station 120. Each communication cell covers a geographical area, so that a wide area can be covered by deploying multiple contiguous or overlapping cells. A mobile terminal 140 is illustrated communicating in one cell 110, and is able to move around the system 100.

A base station 120 includes one or more radio transceivers, to provide radio coverage for one or more cells (also called cell sectors, or sectors). Each base station 120 is connected to a network “backbone”, or core network infrastructure (not shown), which enables communications between base stations, other parts of the mobile communications network, and other networks, such as the public-switched telephone network (PSTN) and the Internet. The example system of FIG. 1 shows one base station 120 per cell, although other configurations are well known, such as those in which a single base station 120 serves multiple sectors, perhaps using different frequencies.

During a call or data session, as well as during idle mode, a mobile terminal 140 is free to move about the geography. In doing so, it may occasionally leave a first cell and enter a new cell neighboring the first. The cell serving a particular mobile station may thus change several times during an active communication session. The process of changing the cell while an active radio link is established between the mobile terminal and the base station is called hand-off or handover. The handover decision process is usually based on a determination of the quality of signals received at the mobile terminal from each of several available and otherwise suitable base station transmitters. Depending on the particular network, the handover decision may be made using information gathered by a network element controlling one or more base station sites, the serving base station, the mobile terminal, or some combination.

In any event, a list of known neighbors, a so-called neighbor cell list, may be used by either or both of the network 100 and the mobile terminal 140 to enable reliable handover between cells. For instance, the network 100 can store information, e.g., in Radio Network Controller elements (not shown), relating to a set of neighbor cells for each cell in the system. Upon a determination at either a network element or at the mobile station that handover is necessary, a “best” cell is identified for supporting a continued radio link with the mobile terminal. This identification of a best cell is typically based upon signal quality measurements made (by the mobile terminal) of signals transmitted by the serving cell and neighbor cells. Thus, a neighbor cell list may be used to map measurements to candidate handover cells.

In existing systems, the mobile terminal 140 typically detects and measures cell operating parameters for neighboring cells by measuring broadcasted signals from the neighbor cells. One measured operating parameter is a cell identifier which typically consists of a physical layer identifier such as a scrambling code that is non-uniquely assigned to the cell. Other measured operating parameters also relate to the signal quality of the neighbor cell, and may include signal strength, signal quality (e.g., signal-to-noise-plus-interference ratio), and timing information. In some networks, one or more of these operating parameters may be reported to a network control entity (e.g., a Radio Network Controller) by the mobile station, typically by transmitting measurement data to the serving base station over an uplink control channel. When the quality of a neighbor cell is considered better than the current serving cell, a handover from the serving cell to the chosen neighbor cell (a “target” cell) may be directed by the network. In some systems, a handover may be initiated by a mobile station, based on similar criteria, in addition to or instead of network-initiated handovers. In either event, the target cell for the handover then becomes the serving cell for the mobile terminal.

As noted above, in prior art systems, a mobile terminal 140 typically maintains a single neighbor cell list. In FIG. 1, a portion of an exemplary neighbor cell list 150 is illustrated. Neighbor cell list 150 includes frequency designations corresponding to each of the cells surrounding the current location of mobile terminal 140. Neighbor cell list 150 may also include other information (not shown), such as scrambling codes, cell identifiers, etc. Those skilled in the art will appreciate that the network configuration of FIG. 1 is simplified. In practice, especially with the deployment of multi-layer systems (e.g., W-CDMA cells overlapping or neighboring GSM cells, or micro-cells within a macro-cell), the arrangements of neighboring cells can be quite varied, and the number of potential neighbors quite large.

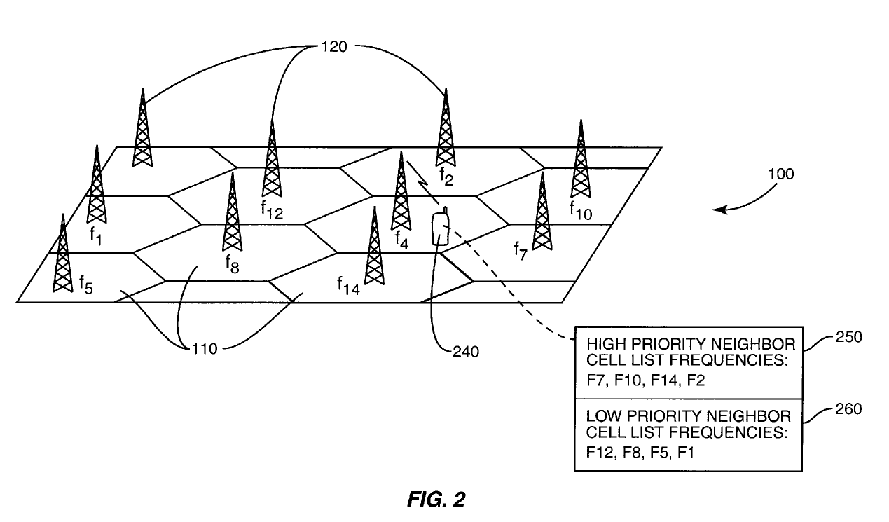

FIG. 2 illustrates the same wireless network 100 as FIG. 1, but with a mobile terminal 240 embodying the present invention. In contrast to the mobile terminal 140 of FIG. 1, the exemplary mobile terminal 240 of FIG. 2 employs two distinct neighbor lists, a high-priority neighbor list 250 and a low-priority neighbor list 260. Portions of the high-priority and low-priority neighbor lists 250 and 260 are reproduced in FIG. 2. High-priority neighbor list 250 includes frequency designations corresponding to the neighbor cells closest to the current location of mobile terminal 240. These closest cells represent the most likely targets for a handover or cell re-selection. The low-priority neighbor cell list 260, on the other hand, includes frequency designations corresponding to the remaining cells adjacent to the currently serving cell. These cells are somewhat less likely to be targets for handover or re-selection. Depending on the network tuning and the local geography, mobile terminal 240 may actually be unable to hear several of the cells on the low-priority neighbor list 260. (In FIG. 2, the “closest” cells include only those that are physically adjacent to the serving cell. Those skilled in the art will appreciate that, in general, the highest-priority neighbor cells comprise those cells that are “closest” in the sense that they are most likely to be heard by the mobile station. In a complex system, perhaps including macro-cells and micro-cells and/or overlapping signal coverage from different radio access technologies, the relationship between high-priority signals and physical proximity will likewise be complex.)

The contents of the high-priority neighbor cell list 250 and the low-priority neighbor cell list 260 may be based on system information provided from the base station, or may be assembled by the mobile terminal based on all cells that the mobile terminal was able to observe in a scan of one or more applicable frequency ranges. For instance, in one embodiment, a GSM or WCDMA system may broadcast a list of neighbor cells for inclusion in the neighbor lists. A mobile terminal receiving this list of neighbor cells may divide the list into the high-priority and low-priority lists 250 and 260 using various techniques. For example, the candidate cells may be allocated between the lists based on initial observations of the signal strength or signal quality for each neighbor cell, or based on location data for the mobile terminal and the neighbor cells. In some embodiments, a mobile terminal may initially place all of the neighbor cells identified by the system in the high-priority list 250, moving several of the neighbor cells into the low-priority list 260 as signal quality information is gathered. In such an embodiment, neighbor cells newly identified by the system (such as after a handover is completed) may be automatically placed in the high-priority list, and left there until further information is gathered.

Similar techniques for assigning neighbor cells to high- and low-priority neighbor lists 250 and 260 may be used for those embodiments in which neighbor cells are identified by the mobile terminal by scanning appropriate frequencies. For instance, such a mobile terminal may initially place all neighbor cells identified in an initial frequency scan in a high-priority list 250. After more information is collected, so that the mobile terminal has more accurate signal strength information, for example, one or more of the neighbor cells may be moved to the low-priority list 260.

In general, the high-priority list 250 preferably includes those neighboring cells that are the most likely targets for handover. By reducing the number of high-priority candidates (compared to the total number of neighbors), the candidates can be more quickly and more accurately assessed for handover. Because the signal environment may be continuously changing, however, the lower-priority candidates cannot be completely ignored. Thus, a low-priority list 260 is maintained to keep track of these less likely candidates.

Accordingly, the mobile station periodically measures, and, in some embodiments, reports, the signal strength (or other signal quality metric) from the cells in both the high-priority and low-priority neighbor lists 250 and 260. However, the measurement and/or reporting intervals for cells on the low-priority neighbor list 260 may be less frequent than for those cells on the high-priority neighbor list 250. Further, the mobile station may periodically perform cell identification for cells in the high-priority list 250. It may not be necessary to perform cell identification at all for cells on the low-priority neighbor list 260, since handover to those cells is unlikely. If cell identification is performed for the low-priority neighbor cells, it may in any case be performed less frequently.

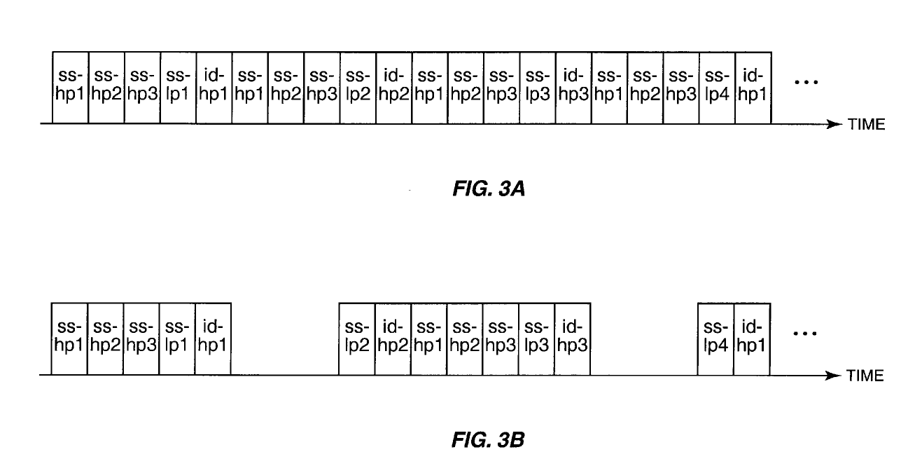

FIG. 3 illustrates exemplary measurement cycles for signal strength measurements and cell identification processes. In FIG. 3A, three high-priority neighbor cells hp1, hp2, and hp3 are monitored, along with four low-priority neighbor cells Ip1, Ip2, Ip3, and Ip4. Signal strength measurements for the high-priority cells, designated SS-hp1, SS-hp2, and SS-hp3, are performed more frequently than signal strength measurements for the low-priority cells (SS-Ip1, SS-Ip2, and so on). Furthermore, cell identification is regularly performed for the high-priority cells, as shown at ID-hp1, ID-hp2, and ID-hp3, but not at all for the low-priority cells.

In some embodiments, the reporting schedule for either the high-priority cells, the low-priority cells, may vary, depending, for example, on the signal strength data observed for the serving cell and/or the high-priority cells. More specifically, fewer measurements may be required when a strong signal is received from the serving cell, or from one or more of the high-priority cells. This is shown in FIG. 3B, where several measurement cycles for the high-priority cells are omitted entirely compared to the schedule of FIG. 3A. As those skilled in the art will appreciate, the fact that several neighbor cells have high signal strengths makes it less likely that all of these neighbor cells will fade away in a given interval of time. As a result, measurements may be performed less frequently, freeing up mobile terminal resources for other tasks and/or conserving battery life.

As briefly noted above, the content of the high-priority and low-priority neighbor cell lists 250 and 260 may vary over time. For instance, a low-priority neighbor cell that “qualifies” for a certain period of time may be moved, or “promoted,” from the low-priority list to the high-priority list. In some embodiments, a neighbor cell that exhibits a signal strength above a pre-determined threshold for one or a pre-determined number of measurements may be promoted. In other embodiments, a minimum number of high-priority neighbor cells may be maintained by moving one or more neighbor cells from the low-priority list 260 to the high-priority list 250 when a neighbor cell on the high-priority cell fades, or falls below a signal strength threshold for a pre-determined period of time.

Likewise, a high-priority neighbor cell that fails to meet certain qualifying criteria for a certain period of time or number of measurements may be moved, or “demoted,” from the high-priority list 250 to the low-priority list 260. Those skilled in the art will appreciate that occasional demotions and promotions will be the norm as a mobile station moves around within a cell. Furthermore, as discussed above, new cells may be added to either of the lists, when first detected or first identified by the network, or removed from one or both lists when no longer heard. Typically, when a new cell is heard for the first time, or is first identified in system information transmitted by the base station, it is directly added to the high-priority list in order to minimize delays in collecting measurements or identifying the unique cell ID.

At handover, a mobile station's existing lists may be maintained as they are, since it is likely that the radio environment just after handover is quite similar to that just before the handover. In those embodiments where neighbor cell information is received from the base station, neighbor cells that are newly identified to the mobile station may be added to the high-priority list 250 as described just above. Similarly, neighbor cells that are no longer listed in new system information received from the base station may be removed from the lists.

In some embodiments, cells not identified by the system as neighboring cells, but heard and identified by the mobile station, may be reported by the mobile terminal to the base station. This information (which may typically include signal strength information) may be used by the system to adapt the neighbor cell information transmitted to mobile terminal. For instance, if the same neighbor cell is identified repeatedly, or by several mobile stations, the neighbor cell may be added to the neighbor cell information transmitted by the base station so that other mobile terminals may monitor the new neighbor cell. In many embodiments, the base station may be configured to maintain reported neighbor data for system tuning and diagnostic purposes, even for neighbor cells that are not included in transmitted system information.

In various embodiments of the present invention, additional factors are used to determine the size and/or composition of the high-priority and low-priority lists 250 and 260. There can be several reasons as to why cells need to be moved between the differently prioritized lists. For example, if the serving cell's signal strength becomes low, a handover is more likely. Under these circumstances, the high-priority list 250 may be adjusted to include more neighbor cells by promoting one or more cells from the low-priority list 260. On the other hand, if the serving cell's signal strength is strong and clear, then perhaps fewer cells need to be kept in the high-priority list. In such a case, one or more of the neighbor cells in the high-priority list, perhaps those with the lowest measured signal strength, or signal quality, may be demoted to the low-priority list 260. In some embodiments, a neighbor cell exhibiting considerable deviations in measured signal strength may be moved between the lists. In some cases, such a neighbor cell might be demoted, in the event that several high-signal-strength neighbors are currently being monitored. In others, such a neighbor cell might actually be promoted, for more frequent monitoring, especially in the case where only a small number of high-quality neighbors are observed.

Identification of neighboring cells is a distinct process from signal strength measurement, and may not be required in all circumstances. Signal strength is generally measured on a regular schedule (albeit more often for higher-priority neighboring cells), but the cell's unique identity only needs to be confirmed in certain cases. In some embodiments, for example, the cell identity for a neighbor cell is confirmed before adding a neighbor to the high-priority list 250, or before promoting a neighbor cell from the low-priority list 260 to the high-priority list 250.

The unique cell identification for cells considered to be strong handover candidates should be known because a handover can be requested at short notice. On the other hand, a cell in the low-priority list 260 will generally not be considered a strong handover candidate. Therefore, it is less important to be sure that the monitored signal for this cell actually corresponds to the proper unique cell identification. The cell identity for cells on both the high-priority and low-priority lists 250 and 260 may be checked periodically. However, to conserve resources, the interval may be different for the high-priority and low-priority lists 250 and 260. In some embodiments, the identity of cells on either or both lists may be re-confirmed upon the occurrence of certain events. For instance, the identity of cells on either or both lists may be confirmed upon cell re-selection, or when the mobile station determines that it has traveled a pre-determined distance, to confirm that the signals being measured by the mobile station are from the same cells.

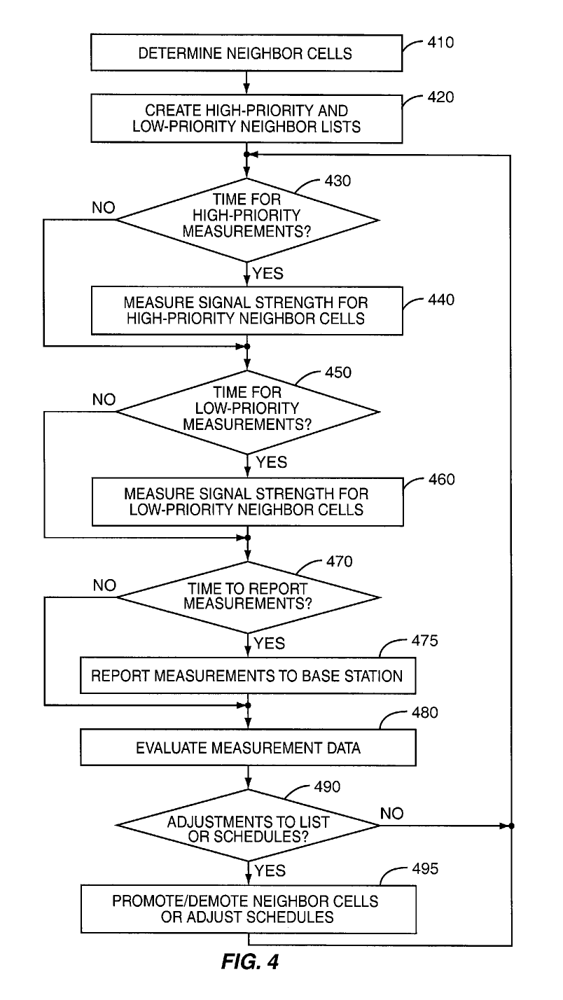

FIG. 4 illustrates an exemplary method for maintaining neighbor cell information at a mobile station in accordance with one or more embodiments of the present invention. The illustrated method begins at block 410, with the determination of neighbor cells to be monitored. As noted above, candidate neighbor cells may be identified in some embodiments from system information transmitted to the mobile station by the serving base station. In other embodiments, a list of candidate neighbor cells is determined by scanning one or more frequency bands to find signals transmitted by neighboring cell sites. Some embodiments may use a mixture of the two techniques.

In any case, the candidate neighbor cells that are to be monitored are divided into at least one high-priority list and at least one low-priority list, as shown at block 420. As discussed extensively above, the allocation of candidate neighbor cells to the high- and low- priority list (or lists) may be made according to a number of factors, including signal strength. Those skilled in the art will appreciate that multiple high- and/or low-priority lists may be used. In some embodiments, for instance, candidate cells may be divided between multiple high- and/or low-priority lists according to cell type (e.g., macro- or microcell), or signal type (e.g., GSM or W-CDMA), as well as by signal quality measures. Each of the high- and low-priority lists may be associated with a distinct schedule for signal quality measurements and/or cell identification confirmation.

Accordingly, at block 430, a schedule associated with the high-priority list is consulted to determine when to make signal strength measurements for the high-priority cells. At the appropriate intervals, signals from the high-priority cells are measured, as shown at block 440. In the same manner, a separate schedule associated with the low-priority list is consulted at block 450; at scheduled intervals, signal strength measurements are made at block 460.

Measurement data is reported to the serving base station at blocks 470 and 475, according to yet another schedule. In some embodiments, this schedule may coincide with one or the other of the low-priority and high-priority measurement schedules. In others, the reporting schedule may be completely independent of the measurement schedules. (In still others, measurement data for one or both of the low-priority and high-priority lists may not be reported at all.)

At block 480, signal strength or other signal quality information is evaluated (by the mobile station, although possibly by the serving base station, or other network element) to determine whether adjustments to the neighbor lists and/or adjustments to one or both of the measurement schedules are needed. Adjustments to the neighbor lists and/or to the measurement schedules are shown at blocks 490 and 495. Although the data evaluation and neighbor list/measurement schedule adjustment processes are shown in FIG. 4 as repeated for each pass through the processing loop, those skilled in the art will appreciate that these processes may be performed on a schedule independent from the measurement schedules. As noted above, signal strength or other signal quality measurements for a given cell may be analyzed to determine whether that cell should be demoted or promoted. In some embodiments, signal strength or signal quality measurements for the entire high-priority list may be analyzed, to determine whether the size of that list should be adjusted, or whether the criteria for entry should be adjusted. Thus, in some embodiments, the number of high-priority neighbor cells may be adjusted upwards if the number of cells having signal strengths above a pre-determined threshold falls below a pre-determined quantity. Similarly, the number of high-priority cells may be reduced, in some embodiments, when the signal strengths associated with the high-priority cells are particularly high.

Similar criteria may be evaluated to determine whether measurement schedules for either the high-priority list or the low-priority list, or both, should be adjusted. For instance, measurements for candidate cells in the high-priority list may be made less frequently if at least a pre-determined minimum number of cells in the high-priority list have signal strength measurements exceeding a pre-determined threshold. Similarly, measurements for high-priority cells may be made more frequently if fewer than a pre-determined minimum number of cells in the high-priority lest have signal strengths exceeding a pre-determined threshold. In some embodiments, adjustments to the measurement schedule for the low-priority list may also be made. For example, if high-signal-strength candidate cells are plentiful, low-priority cell measurements may be reduced, as the probability that a low-priority cell will be needed is lower.

Not shown in FIG. 4 are cell identity confirmation procedures, which may be carried out in parallel with the signal quality measurements. Thus, in some embodiments, cell identification confirmation may be periodically performed at block 440 (for high-priority cells), and possibly at block 460 (for low-priority cells), along with signal strength measurements for the corresponding cells. However, as noted above, in some embodiments cell identities for candidate cells may be periodically confirmed at intervals that are longer than the measurement intervals. In other embodiments, cell identity confirmation for low-priority cells may be omitted entirely.

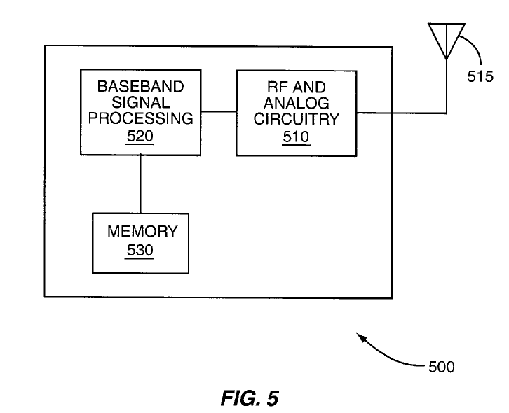

FIG. 5 provides a functional block diagram for an exemplary mobile terminal 500, configured to maintain neighbor cell information according to one or more of the methods described herein. Mobile terminal 500 comprises analog and radio frequency (RF) circuitry 510 connected to antenna 515, baseband signal processing unit 520, and memory 530. Analog and RF circuitry 510 comprises conventional radio-frequency components for receiving and sending transmissions between mobile station 500 and a serving base station. Baseband signal processing unit 520, which may comprise one or more general-purpose or customized microprocessors, microcontrollers, and or digital signal processors (DSPs), is configured, in some embodiments using program code stored in memory 530, to maintain a high-priority neighbor list and a low-priority neighbor list, each list comprising one or more neighbor cell entries corresponding to candidate cells for handover. Baseband signal processing unit 520 and RF and analog circuitry 510 are further configured to make signal strength measurements for candidate cells in the high-priority list according to a first measurement schedule, and to make signal strength measurements for candidate cells in the low-priority list according to a second measurement schedule. The second measurement schedule involves less frequent measurements in one or more embodiments.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of maintaining neighbor cell information at a mobile station for use in handover operations, said method comprising:
maintaining a high-priority neighbor list and a low-priority neighbor list, each list comprising one or more neighbor cell entries corresponding to candidate cells for handover;
making signal strength measurements for candidate cells in said high-priority list according to a first measurement schedule; and
making signal strength measurements for candidate cells in said low-priority list according to a second measurement schedule.

2. The method of claim 1, wherein maintaining a high-priority neighbor list and a low-priority neighbor list comprises moving a neighbor cell entry from the high-priority neighbor list to the low-priority neighbor list if signal strength measurements for the corresponding candidate cell deviate beyond a pre-determined amount.

3. The method of claim 1, wherein maintaining a high-priority list and a low-priority neighbor list comprises moving a neighbor cell entry from the high-priority neighbor list to the low-priority neighbor list if the signal strength measurements for the corresponding candidate cell fall below a first pre-determined level for a first pre-determined interval of time or a first pre-determined number of measurements.

4. The method of claim 1, wherein maintaining a high-priority list and a low-priority neighbor list comprises moving a neighbor cell entry from the low-priority neighbor list to the high-priority neighbor list if the signal strength measurements for the corresponding candidate cell are above a second pre-determined level for a second pre-determined interval of time or a second pre-determined number of measurements.

5. The method of claim 4, further comprising confirming a cell identity associated with a candidate cell before moving the corresponding entry to the high-priority list.

6. The method of claim 1, wherein maintaining a high-priority list comprises evaluating signal strength measurements for candidate cells in the high-priority list or the serving cell, or both, and adjusting the number of entries in the high-priority list based on said evaluating.

7. The method of claim 6, wherein adjusting the number of entries in the high-priority list comprises removing one or more entries from the high-priority list if at least a pre-determined minimum number of entries in the high-priority list correspond to signal strength measurements exceeding a first pre-determined threshold.

8. The method of claim 6, wherein adjusting the number of entries in the high-priority list comprises adding one or more entries to the high-priority list if fewer than a pre-determined minimum number of entries in the high-priority list correspond to signal strength measurements exceeding a second pre-determined threshold.

9. The method of claim 1, wherein maintaining a high-priority list comprises evaluating one or more signal strength measurements for the serving cell and adjusting the first measurement schedule based on said evaluating.

10. The method of claim 1, wherein maintaining a high-priority list comprises evaluating signal strength measurements for candidate cells in the high-priority list and adjusting the first measurement schedule based on said evaluating.

11. The method of claim 10, wherein adjusting the first measurement schedule comprises making signal measurements for candidate cells in said high-priority list less frequently if at least a minimum number of entries in the high-priority list correspond to signal strength measurements exceeding a first pre-determined threshold.

12. The method of claim 1, further comprising receiving one or more neighbor cell identifiers from a serving base station, comparing the received neighbor cell identifiers to the high-priority list and low-priority list, and adding neighbor cell entries corresponding to new neighbor cell identifiers to the high-priority list.

13. The method of claim 1, further comprising scanning one or more frequency ranges for new neighbor cells and adding neighbor cell entries for new neighbor cells to the high-priority list.

14. The method of claim 1, further comprising:
confirming cell identities for candidate cells in said high-priority list according to a first identity confirmation schedule; and
confirming cell identifies for candidate cells in said low-priority list according to a second identity confirmation schedule.

15. The method of claim 1, further comprising evaluating a distance traveled by the mobile station since cell identities for candidate cells in the high-priority cell were previously confirmed, and confirming cell identities for candidate cells in the high-priority list if said distance exceeds a pre-determined distance.

16. The method of claim 1, further comprising evaluating movement by the mobile station and adjusting the first measurement schedule, the second measurement schedule, or both, based on said movement.

17. The method of claim 1, further comprising reporting to a base station signal strength measurements for candidate cells in the high-priority list according to a first reporting schedule and reporting signal strength measurements for candidate cells in the low-priority list according to a second reporting schedule.

18. A mobile station comprising
a transceiver section, and
one or more processing circuits configured to:
maintain a high-priority neighbor list and a low-priority neighbor list, each list comprising one or more neighbor cell entries corresponding to candidate cells for handover;
make signal strength measurements for candidate cells in said high-priority list, using said transceiver section, according to a first measurement schedule; and
make signal strength measurements for candidate cells in said low-priority list, using said transceiver section, according to a second measurement schedule.

19. The mobile station of claim 18, wherein the one or more processing circuits are configured to maintain the high-priority neighbor list and low-priority neighbor list by moving a neighbor cell entry from the high-priority neighbor list to the low-priority neighbor list if the signal strength measurements for the corresponding candidate cell fall below a first pre-determined level for a first pre-determined interval of time or a first pre-determined number of measurements.

20. The mobile station of claim 18, wherein the one or more processing circuits are configured to maintain the high-priority neighbor list and low-priority neighbor list by moving a neighbor cell entry from the low-priority neighbor list to the high-priority neighbor list if the signal strength measurements for the corresponding candidate cell are above a second pre-determined level for a second pre-determined interval of time or a second pre-determined number of measurements.

21. The mobile station of claim 18, wherein the one or more processing circuits are configured to maintain the high-priority neighbor list and low-priority neighbor list by evaluating signal strength measurements for candidate cells in the high-priority list or the serving cell, or both, and adjusting the number of entries in the high-priority list based on said evaluating.

22. The mobile station of claim 21, wherein the one or more processing circuits are configured to adjust the number of entries in the high-priority list by removing one or more entries from the high-priority list if at least a pre-determined minimum number of entries in the high-priority list correspond to signal strength measurements exceeding a first pre-determined threshold.

23. The mobile station of claim 18, wherein the one or more processing circuits are configured to maintain the high-priority list by evaluating signal strength measurements for candidate cells in the high-priority list or the serving cell, or both, and adjusting the first measurement schedule based on said evaluating.

24. The mobile station of claim 23, wherein the one or more processing circuits are configured to adjust the first measurement schedule by making signal measurements for candidate cells in said high-priority list less frequently if at least a minimum number of entries in the high-priority list correspond to signal strength measurements exceeding a first pre-determined threshold.

25. The mobile station of claim 18, wherein the one or more processing circuits are further configured to:
receive one or more neighbor cell identifiers from a serving base station;
compare the received neighbor cell identifiers to the high-priority list and low-priority list; and
add neighbor cell entries corresponding to new neighbor cell identifiers to the high-priority list.
